(19) United States
(12) Patent Application Publication
(10) Pub. No.: US 2014/0182114 A1
(43) Pub. Date: Jul. 3, 2014

(54) FASTENER

(71) Applicant: Kenneth Dale Stokes, Sylvania, OH (US)

(72) Inventor: Kenneth Dale Stokes, Sylvania, OH (US)

(21) Appl. No.: 13/832,434

(22) Filed: Mar. 15, 2013

Related U.S. Application Data
(60) Provisional application No. 61/748,294, filed on Jan. 2, 2013.

(51) Int. Cl. F16B 19/00

(52) U.S. Cl. CPC F16B 19/00
USPC 29/525.03; 24/706.2; 470/27; 24/303

(57) ABSTRACT

A fastener for removably attaching a filter material to a mounting structure includes a base and corresponding retainer. The base includes an elongate shaft having a first end and a second end, the first end including an attachment means for removably attaching the fastener to the mounting structure. The retainer is configured to be removably received onto the shaft to secure at least a portion of the filter material between the retainer and the base.

### CROSS-REFERENCE TO RELATED APPLICATION

This application claims the benefit of U.S. Provisional Patent Application Ser. No. 61/748,294 filed Jan. 2, 2013, the entire disclosure of which is hereby incorporated herein by reference.

### FIELD OF THE INVENTION

The present invention relates generally to a fastener and, more particularly, to a fastener configured to removably attach a material to a mounting structure.

### BACKGROUND OF THE INVENTION

Many different types of fasteners are used in structures and assemblies to secure one panel or covering to another component of a structure or assembly. One form of such fasteners includes a threaded body having head formed thereon. The threaded body engages a threaded bore or a blind bore of the structure or assembly. Other forms of such fasteners include magnetic fasteners. Magnetic fasteners are generally considered to be advantageous to conventional fasteners because of the convenience they offer. For example, components with a pair of counterpart magnetic fasteners mounted thereon can be easily joined and separated. More particularly, the components can be easily joined because, once the corresponding counterparts are in mutual proximity, mutual magnetic attraction will bring the magnetic fasteners together.

It would be desirable to produce a fastener which is configured to removably attach a material to a mounting structure, wherein a structural complexity and cost thereof are minimized.

### SUMMARY OF THE INVENTION

In concordance and agreement with the present disclosure, a fastener which is configured to removably attach a material to a mounting structure, wherein a structural complexity and cost thereof are minimized, has surprisingly been discovered.

In one embodiment, a fastener assembly, comprises: a base including an elongate shaft having a first end and a second end, the first end including an attachment means for removably attaching the fastener assembly to a mounting structure; and a retainer configured to be removably received onto the shaft to secure at least a portion of a material between the retainer and the base.

In another embodiment the invention relates to a method of producing a fastener assembly.

The method comprises the step of: forming a base from a first material, the base including an elongate shaft configured to removably receive a retainer thereon for securing at least a portion of a material between the retainer and the base, wherein a first end of the shaft includes an attachment means for removably attaching the fastener to a mounting structure.

In yet another embodiment, the invention relates to a method of removably attaching a filter material to a mounting structure.

The method comprises the steps of: providing a fastener assembly including a base and a retainer; securing at least a portion of the filter material between the base and the retainer of the fastener assembly; and disposing the fastener assembly and the filter material onto the mounting structure.

### BRIEF DESCRIPTION OF THE DRAWINGS

The above, as well as other objects and advantages of the invention, will become readily apparent to those skilled in the art from reading the following detailed description of the invention when considered in the light of the accompanying drawings in which:

FIG. 1 is an exploded top perspective view of a fastener assembly according to the present invention, wherein the fastener assembly includes a retainer and a base having a first recess and a second recess;

FIG. 2 is an exploded bottom perspective view of the fastener assembly illustrated in FIG. 1;

FIG. 3 is a cross-sectional view of the fastener assembly illustrated in FIGS. 1-2, showing the second recess having a filler material disposed therein and a portion of a material to be removably attached to a mounting structure compressed between the retainer and the base;

FIG. 4 is a top perspective view of the fastener assembly illustrated in FIG. 3, showing a pointed end portion of the base being removed;

FIG. 5 is a bottom perspective view of a fastener assembly according to another embodiment of the invention, showing a separate reusable component configured to be removably received onto a base of the fastener assembly to allow a portion of the base to be inserted through a material;

FIG. 6 is a top perspective view of a fastener assembly according to yet another embodiment of the invention, showing a separate reusable component having a generally spherical portion configured to be removably received into a socket formed in a base of the fastener assembly to allow a portion of the base to be inserted through a material;

FIG. 7 is an enlarged perspective view of a magnetic interface of the fastener assembly illustrated in FIGS. 1-6 having an attachment means disposed thereon and configured to removably attach the material to a non-magnetic mounting structure; and

FIG. 8 is a perspective view of an air conditioning unit having the material attached thereto by a plurality of the fastener assemblies illustrated in one of FIGS. 1-4, 5, and 6 including the magnetic interfaces illustrated in FIG. 7.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

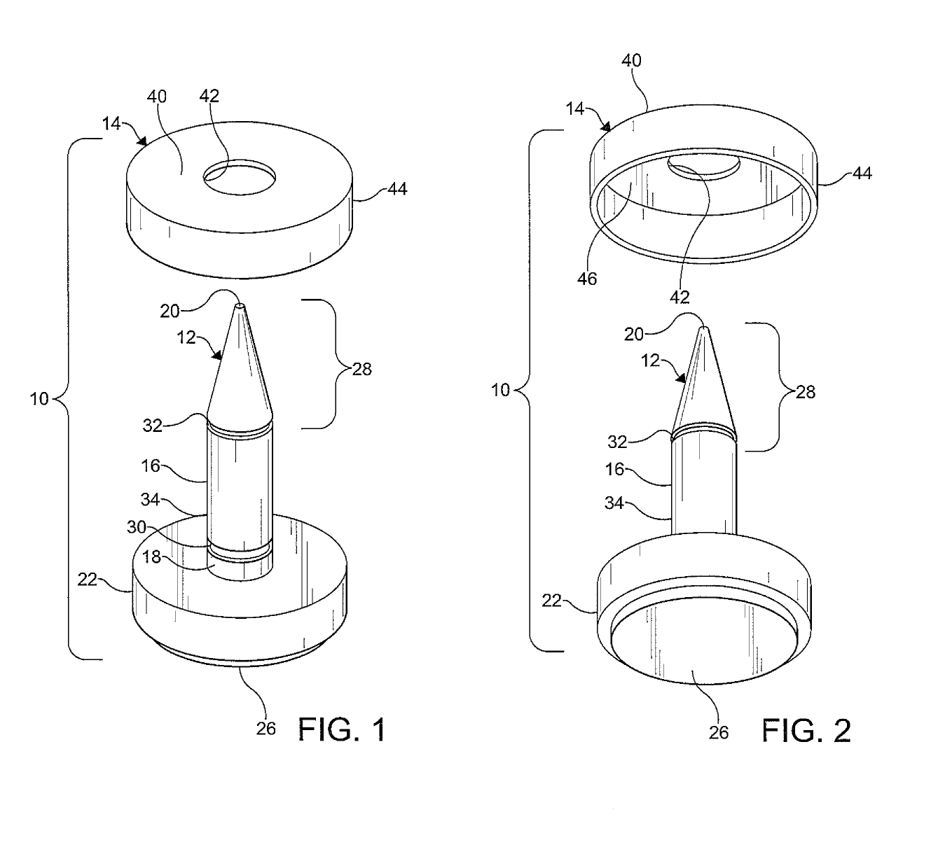

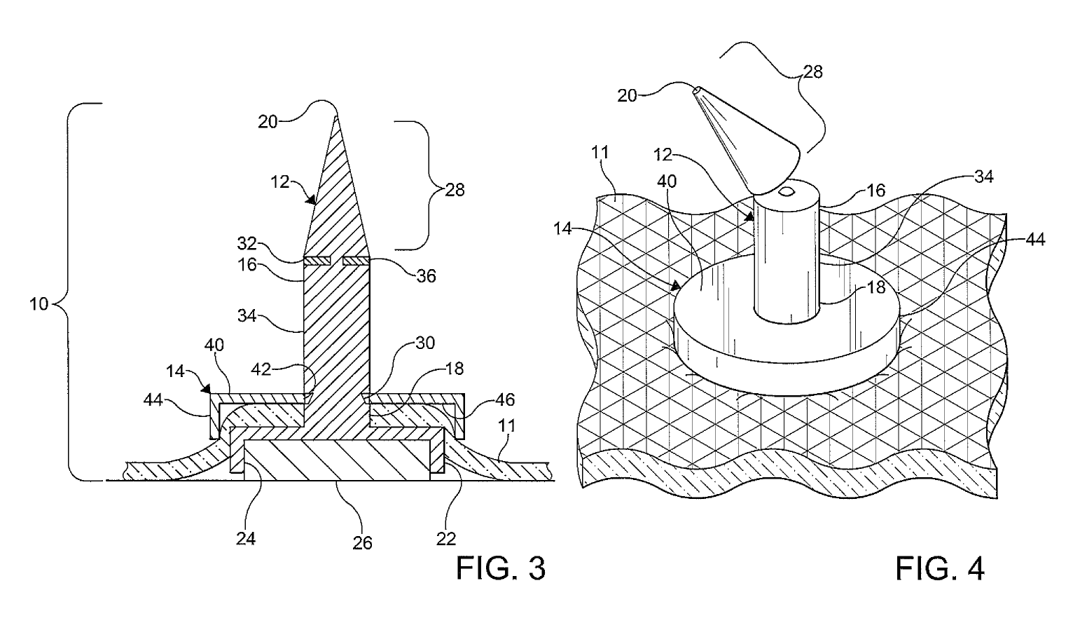

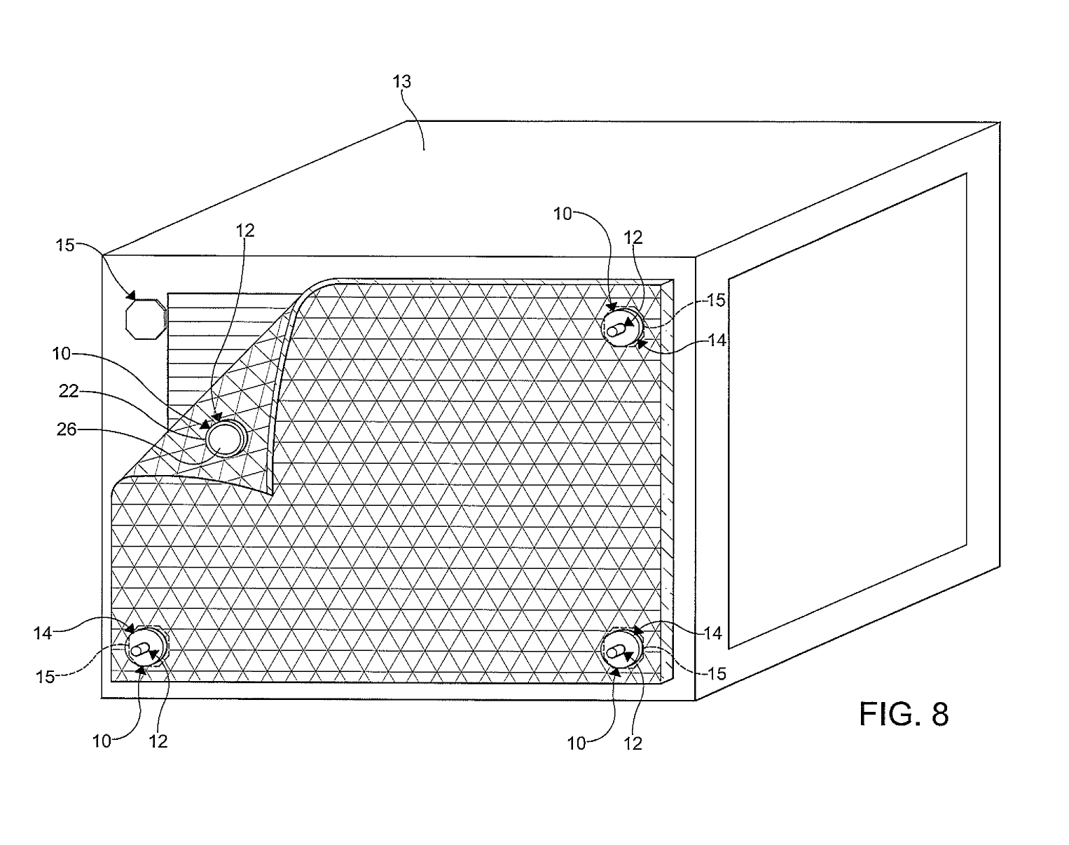

FIGS. 1-4 depict a fastener assembly 10 according to the present invention. The fastener assembly 10 shown is used to removably attach a material 11 (e.g. a washable filter material shown in FIGS. 3-6 and 8) to a mounting structure 13 such as an inlet grate of a heating, ventilating, and air conditioning unit shown in FIG. 8, for example. The fastener assembly 10 includes a base 12 and a retainer 14. Each of the base 12 and the retainer 14 can be formed from any suitable material such as a plastic material, a non-magnetic metal material, a magnetic metal material, or a combination thereof, for example.

In certain embodiments, the fastener assembly 10 further includes a magnetic interface 15 (shown in FIG. 7) configured to be removably or permanently affixed to a mounting structure 13 that is not magnetic in order to removably attach the material 11 to the mounting structure 13. As illustrated in FIG. 7, the magnetic interface 15 can be a plate-like member or a disk formed from a magnetically attractive material such as an iron material, a nickel material, a cobalt material, or a combination thereof, for example. It is understood, however, that the magnetic interface 15 can be any member of a suitable size and shape. Various attachment means can be used to removably or permanently affix the magnetic interface 15 to the non-magnetic mounting structure 13 such as a double-sided tape 17 having at least one removable protective covering 19 disposed on one surface thereof, for example. Those skilled in the art will appreciate that the fastener assembly 10 can be used in other applications and systems than described herein if desired.

With renewed reference to FIGS. 1-4, the base 12 includes an elongate shaft 16 having a first end 18 and a second end 20 opposite the first end 18. The shaft 16 shown has a generally circular cross-sectional shape. It is understood, however, that the shaft 16 can have any shape and size as desired. The first end 18 of the shaft 16 is configured to facilitate removable attachment of the fastener assembly 10 to the mounting structure 13 or the magnetic interface 15 disposed on the mounting structure 13. In certain embodiments, the first end 18 has a radially outwardly extending annular flange 22 formed thereon. A cavity 24 formed in the first end 18 receives an attachment means 26 therein such as a magnet, and more particularly a neodymium magnet, for example. The cavity 24 and the attachment means 26 can have any shape and size as desired such as circular, rectangular, square, triangular, or an irregular shape, for example. It is understood that the first end 18 may include other means of removably attaching the fastener assembly 10 to the mounting structure 13 or the magnetic interface 15 such as adhesive, hook and loop tape, and the like, for example.

In certain embodiments, the second end 20 is tapered forming a substantially conical or pointed end portion 28 of the shaft 16. The pointed end portion 28 allows the shaft 16 to be easily inserted through the material 11 without a predefined opening formed therein. The second end 20 includes spaced apart first and second annular recesses 30, 32 formed in an outer surface 34 thereof. Additional or fewer recesses than shown can be employed if desired. The recesses 30, 32 shown extend continuously about a circumference of the shaft 16. The first recess 30 is formed adjacent the first end 18 of the base 12 and configured to secure the retainer 14 to the base 12. The second recess 32 is formed adjacent the pointed end portion 28 of the second end 20 of the shaft 16 and is configured to facilitate a separation of the pointed end portion 28 from the base 12, as shown in FIG. 4. In certain embodiments, the second recess 32 initially includes a filler material 36 disposed therein to militate against an ensnaring of the material 11 during an insertion of the shaft 16 of the base 12 of the fastener assembly 10 through the material 11. It is understood, however, that the first recess 30 or both of the recesses 30, 32 may initially include the filler material 36 to militate against an ensnaring of the material 11 during the insertion of the shaft 16 of the base 12 of the fastener assembly 10 through the material 11 if desired.

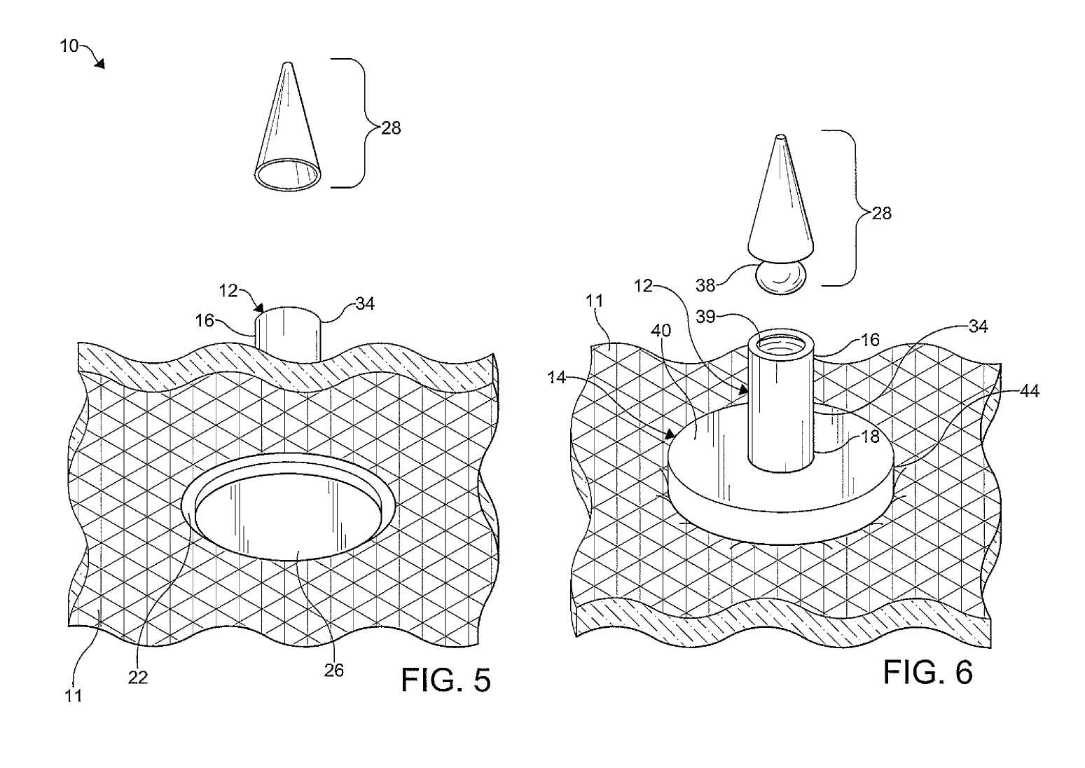

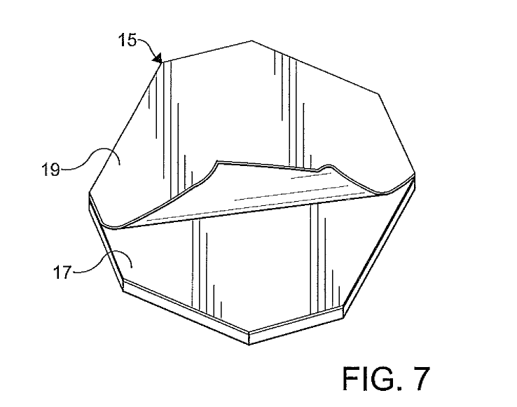

Alternatively, the pointed end portion 28 of the base 12 may be a separate reusable component. In a non-limiting example illustrated in FIG. 5, the pointed end portion 28 of the base 12 is a separate reusable hollow component which is configured to be removably received onto the shaft 16 of the fastener assembly 10 to allow the shaft 16 to be inserted through the material 11. In another non-limiting example, the pointed end portion 28 of the base 12 is a separate reusable component having a generally spherical portion 38 formed thereon which is configured to be removably received into a socket 39 formed in the shaft 16 of the base 12 as shown in FIG. 6. It is understood, however, that the reusable pointed end portion 28 can be removably coupled to the shaft 16 of the base 12 by any means as desired such as an interference fit, a snap-fit, a threaded connection, a twist connection, and the like, for example. The reusable pointed end portion 28 can be used repeatedly for numerous fastener assemblies 10, thereby minimizing waste and resources required to produce the pointed end portion 28 for each fastener assembly 10.

In certain embodiments, the retainer 14 is a generally circular body 40 having a central aperture 42 formed therein and a skirt portion 44 depending therefrom. An inner diameter of the central aperture 42 is slightly smaller than an outer diameter of the shaft 16 of the fastener assembly 10 to allow a portion of the body 40 of the retainer 14 to be received into the first recess 30, and thereby secure the retainer 14 on the base 12. The skirt portion 44 extends from an outer peripheral edge of the body 40 to form a cavity 46 for receiving the material 11 therein. An outer diameter of the skirt portion 44 is larger than an outer diameter of the flange 22 of the base 12 to allow the material 11 to be received therebetween.

In operation, the shaft 16 of the base 12 of the fastener assembly 10 is inserted into the material 11 having the pointed end portion 28 of the base 12 pierce through the material 11. The shaft 16 of the base 12 is caused to extend through the material 11 until the material 11 abuts the flange 22 of the base 12 and the shaft 16 extends outwardly from the material 11. Thereafter, the retainer 14 is placed onto the shaft 16 of the base 12 having the shaft 16 extend through the central aperture 42. The retainer 14 travels along the shaft 16 until a portion of the body 40 of the retainer 14 is received into the first recess 30 and secured to the base 12. As the retainer 14 is secured on the base 12, the material 11 is received into the cavity 46 formed in the retainer 14 and compressed between the retainer 14 and base 12, thereby securing the fastener assembly 10 to the material 11. When the fastener assembly 10 is secured to the material 11, the flange 22 is caused to be received into the material 11 which causes a surface of the attachment means 26 to be substantially flush or recessed within a surface of the material 11.

Once the fastener assembly 10 is secured to the material 11, the pointed end portion 28 of the base 12 is removed. In certain embodiments, the pointed end portion 28 is broken off from the base 12 at the second recess 32 by a snapping action. It is understood, however, that the pointed end portion 28 can be removed from the base 12 by other means as desired such as using a hand tool (i.e. material snips, scissors, radial cutter, etc.), for example. In other embodiments, the pointed end portion 28 is a separate reusable component and is easily removed from the base 12 without having to fracture the shaft 16. Once the pointed end portion 28 is removed, the attachment means 26 disposed in the base 12 is caused to contact the mounting structure 13 or the magnetic interface 15 disposed on the mounting structure 13. Because the surface of the attachment means 26 is substantially flush or recessed within the surface of the material 11, a space between the material 11 and the mounting structure 13 is minimized, which militates against debris and other undesired material from bypassing the material 11 and reaching the mounting structure 13.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fastener assembly, comprising:
a base including an elongate shaft having a first end and a second end, the first end including an attachment means for removably attaching the fastener assembly to a mounting structure; and
a retainer configured to be removably received onto the shaft to secure at least a portion of a material between the retainer and the base.

2. The fastener assembly of claim 1, wherein the first end of the base includes at least one recess formed therein.

3. The fastener assembly of claim 2, wherein the at least one recess of the first end of the base is configured to receive a portion of the retainer therein.

4. The fastener assembly of claim 1, wherein a portion of the second end of the base is configured to be removed from the base.

5. The fastener assembly of claim 1, wherein the second end of the base includes at least one recess formed therein.

6. The fastener assembly of claim 5, wherein the at least one recess of the second end of the base includes a filler material disposed therein.

7. The fastener assembly of claim 1, wherein the attachment means is a magnet.

8. The fastener assembly of claim 1, further comprising an interface configured to attach the fastener assembly to a non-magnetic mounting structure.

9. The fastener assembly of claim 8, wherein the interface is formed from a magnetically attractive material.

10. The fastener assembly of claim 1, further comprising a reusable component configured to be removably received on the base to facilitate insertion of the second end of the base through the material.

11. A method of producing a fastener assembly, comprising the step of:
forming a base from a first material, the base including an elongate shaft configured to removably receive a retainer thereon for securing at least a portion of a material between the retainer and the base, wherein a first end of the shaft includes an attachment means for removably attaching the fastener to a mounting structure.

12. The method of claim 11, further comprising the step of forming the retainer from a second material.

13. The method of claim 12, wherein the first material and the second material are substantially the same.

14. The method of claim 11, wherein the attachment means is a magnet.

15. The method of claim 11, further comprising the step of forming an interface from a magnetically attractive material.

16. The method of claim 11, further comprising the step of forming a reusable component configured to be removably received on the base to facilitate insertion of a second end of the base through the material

17. A method of removably attaching a filter material to a mounting structure, comprising the steps of:
providing a fastener assembly including a base and a retainer;
securing at least a portion of the filter material between the base and the retainer of the fastener assembly; and
disposing the fastener assembly and the filter material onto the mounting structure.

18. The method of claim 17, further comprising the step of removing a portion of the base.

19. The method of claim 17, wherein the fastener assembly includes a magnetic interface configured to removably receive the base of the fastener assembly thereon.

20. The method of claim 19, further comprising the step of disposing the magnetic interface on the mounting structure, wherein the mounting structure is a non-magnetic mounting structure.
